(19) United States
(12) Patent Application Publication
(10) Pub. No.: US 2006/0179452 A1
(43) Pub. Date: Aug. 10, 2006

(54) Method and system for providing mobile subscription content access

(76) Inventors: Guillermo O. Amodeo, Scotland (GB); Elizabeth W. Cameron, Scotland (GB); Gavin M. Cameron, Scotland (GB); Manjit S. Saggu, Scotland (GB)

Correspondence Address: DILLION & YUDELL LLP, 8911 N. CAPITAL OF TEXAS HWY, SUITE 2110, AUSTIN, TX, 78759, US

(21) Appl. No.: 11/360,927

(22) Filed: Feb. 23, 2006

Related U.S. Application Data
(63) Continuation of application No. PCT/GB03/04511, filed on Oct. 17, 2003.

(30) Foreign Application Priority Data
Aug. 23, 2003 (GB) 0319918.9

(51) Int. Cl. H04N 7/025; G06F 13/00; H04N 5/445; G06F 3/00; H04N 7/10; H04N 7/16

(52) U.S. Cl. 725/25; 725/32; 725/39

(57) ABSTRACT

A method for providing mobile subscription content access is disclosed. Initially, subscription contents are stored in a server. The subscription content can be accessed via any terminal coupled to the server by a communication link. In response to an access to any of the subscription contents on an encrypted subscription channel via a terminal, a determination is made as to whether or not a valid receiver is found in the proximity of the terminal. If a valid receiver is found in the proximity of the terminal, an encryption/decryption key is transferred to the valid receiver. With the encryption/decryption key, the subscription contents on an encrypted subscription channel can be accessed via the terminal and the valid receiver.

### CROSS REFERENCE TO RELATED APPLICATIONS

The present application claims benefit of priority under 35 U.S.C. §120 and §365 to the previously filed international patent application number PCT/GB2003/004511 filed on Oct. 17, 2003 with a priority date of Aug. 23, 2003 based upon Great Britain Patent Application No. 0319918.9, both of which are incorporated by reference herein.

### BACKGROUND OF THE INVENTION

1. Technical Field

The present invention relates to mobile subscriptions in general, and in particular to a method and system for providing mobile subscription content access. Still more particularly, the present invention relates to a method and system for allowing a content subscriber to access content anywhere there is a coverage.

2. Description of Related Art

It is known that subscription channels on television can be accessed by a subscriber via a smartcard (i.e., a data carrier with processing function). The smartcard may be carried around and used with a suitable receiver to allow the subscriber to view the paid for channels anywhere there is coverage.

However, the disadvantage of the above-mentioned approach is that different smartcards are required for different activities. With the rapid expansion of the Internet, more content and services are becoming available on the internet from different content providers. Thus, it is preferable for a subscriber to have one portable receiver to allow content to be viewed anywhere web access is provided.

Distribution of services to a device dependent on the device's location is known in the art. However, the prior art service distributions do not address the problem of security. Consequently, it would be desirable to provide an improved method and system for providing mobile subscription content access.

### SUMMARY OF THE INVENTION

In accordance with a preferred embodiment of the present invention, subscription contents are stored in a server. The subscription content can be accessed via any terminal coupled to the server by a communication link. In response to an access to any of the subscription contents on an encrypted subscription channel via a terminal, a determination is made as to whether or not a valid receiver is found in the proximity of the terminal. If a valid receiver is found in the proximity of the terminal, an encryption/ decryption key is transferred to the valid receiver. With the encryption/decryption key, the subscription contents on an encrypted subscription channel can be accessed via the terminal and the valid receiver.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a mobile subscription content access system, in accordance with a preferred embodiment of the present invention;

FIG. 2 is a high-level logic flow diagram of a method for providing mobile subscription content access, in accordance with a preferred embodiment of the present invention; and

FIGS. 3-6 are block diagrams illustrating various functions of a receiver for accessing content from the mobile subscription content access system of FIG. 1, in accordance with a preferred embodiment of the present invention.

### DETAILED DESCRIPTION OF A PREFERRED EMBODIMENT

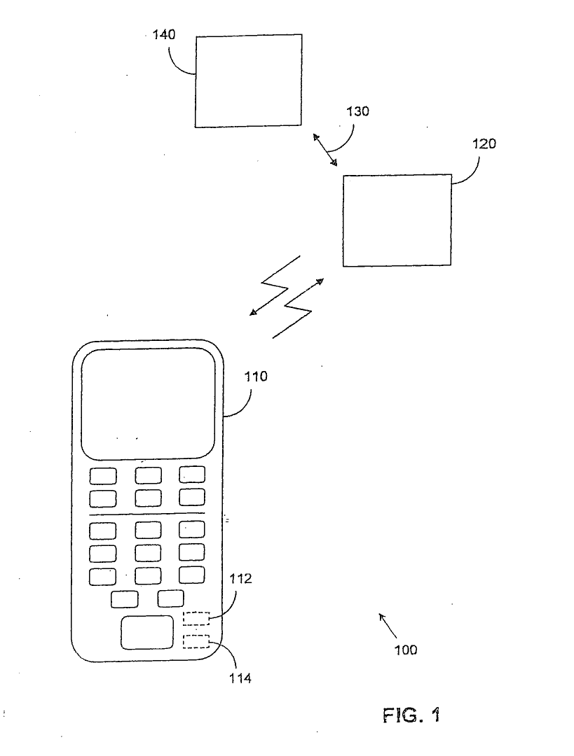

Referring now to the drawings and in particular to FIG. 1, there is depicted a block diagram of a mobile subscription content access system 100, in accordance with a preferred embodiment of the present invention. Mobile subscription content access system 100 allows a person who subscribes to content published for subscription to access such content anywhere there is a suitably equipped terminal/transceiver.

As shown, mobile subscription content access system 100 includes a receiver 110 and a local terminal/transceiver 120. Terminal/transceiver 120 is coupled, via a communication link 130 such as the internet, to a remote server 140 containing various subscription contents. Mobile subscription content access system 100 is expected to have a growth of content being provided on the internet.

In a memory 112, receiver 110 contains all the subscriber's personal details for multiple content providers. Receiver 110 can be a personal digital assistant (PDA) or a mobile phone equipped with wireless capability such as Bluetooth, InfraRed or the like. Memory 112 may be provided to receiver 110 via a smartcard inserted within receiver 110. Transceiver 120 is preferably a set-top box capable of handling multiple media types. Transceiver 120 may also include a smartcard reader and a wireless interface for communicating with receiver 110. As will be described in more detail below, a Bluetooth (or equivalent) link is used to set up transceiver 120 proactively. All that is required is for the subscriber to be located within the range of transceiver 120. Periodic checks may be made for the presence of the subscriber to ensure there is no abuse of mobile subscription content system 100. Within receiver 110, subscribed content received from transceiver 120 is stored within a memory 114.

Subscription content can be audio, video, text or any of the combination. For example, music may be purchased online and be available to the purchaser for subsequent download anywhere, and there is no requirement to purchase compact discs. When a purchaser wants to listen to the music, he/she can visit a web page in order to do so.

An encryption key may either be sent from the source of the content after validation of the subscriber or from information held on receiver 110. Since different content providers may use different encoding techniques, it is preferable to have the decoding algorithm be downloaded prior to any access being granted.

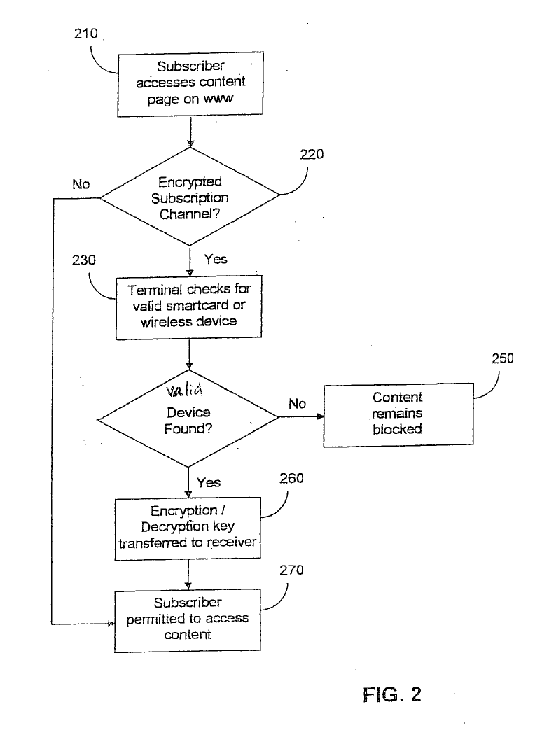

With reference now to FIG. 2, there is depicted a high-level logic flow diagram of a method for providing mobile subscription content access, in accordance with a preferred embodiment of the present invention. Using receiver 110 (from FIG. 1), a subscriber accesses a content page on the world wide web, as shown in block 210. A determination is then made at transceiver 120 (from FIG. 1) as to whether or not the requested content is on an encrypted subscription channel, as depicted in block 220. If not, then the subscriber is permitted to access the content, as shown in block 270. If so, then transceiver 120 checks for a valid smartcard or wireless device (using the information stored in memory 112 of receiver 110), as shown in block 230. If no valid device is found, the requested content remains blocked to the subscriber, as depicted in block 250. If a valid device is found, an appropriate encryption/decryption key is transferred to receiver 110 (and stored in either memory 112 or 114 of receiver 110), as shown in block 260, and the subscriber is permitted to access the requested content, as depicted in block 270.

The appropriate subscribed content may be automatically downloaded from remote server 140 and speculatively cached in memory 114 when receiver 110 becomes within range of transceiver 120. It will be appreciated that such type of access distinguishes system 100 from prior art systems. The encryption algorithms can be stored on receiver 110 to allow multiple subscriptions to be easily transported. In the same manner as a universal remote control device, receiver 110 can be programmed to operate with any suitable receiver. Transceiver 120 may be capable of storing multiple algorithms, and these may only be downloaded on an “as required” basis and once downloaded may be stored locally, for example, in memory 112 or 114, for immediate subsequent use.

System 100 uses a digital identification mechanism to trigger speculative cache fills from a data source, such as from the internet. The digital identification is encrypted for security and also acts as a “pass key” to other services to which a subscriber is entitled. Download to, and access of, the data are to receiver 110 in proximity to the identification means. The data to be cached may be determined by the subscriber's “agent,” that is, a profile that resides elsewhere on the network and with which the subscriber interacts. A pass-through mode may also be provided to gain access to other services, for example, TV channels.

The connection between receiver 110 and transceiver 120 is preferably wireless in order to avoid the need for mating sockets with the key as is required today on some satellite TV systems. By the adoption of relevant standards, ubiquitous usage is envisaged.

Since receiver 110 may act like an electronic passport, an overall control chip may be required that uniquely identifies the user. This is the key personalization module for receiver 110, holding the user's photo identification (ID) and/or biometrics.

In practice, the following concerns may arise:
1. in the event that more than one download device is within range of the identification mechanism, some means of arbitrating the receiving device is needed; and
2. some mechanisms are required to prevent others from accessing the data being downloaded; for example, if the proper subscriber is in a busy area such as an hotel foyer, a train station or an internet cafe, it is important to stop the receiving device from triggering and allowing others to use the proper owner's ID.
   The above-mentioned concerns may be addressed by the use of a bio-recognition system embedded in the identification mechanism, such as a retinal scan, fingerprint recognition or the like, although a simple personal identification (PIN) code may be used as an alternative.

Two exemplary usages of system 100 are as follows:

### EXAMPLE 1

### Business Traveller

A business traveller needs to book a hotel and travel. He is not at his regular work place nor does he have access to his own personal computer (PC). Instead he uses a wireless equipped PC of a colleague to visit his travel agency's website where he arranges all his travel. Instead of having to identify himself to the website he is visiting, the PC has polled by wireless to see if a suitable device is present. Recognizing the device or devices in the area, it is a simple matter for the business traveller to confirm his identity by the use of a PIN or a password. All other information, such as seating preference, loyalty card number, credit card data, etc., are transferred from his portable device, such as a PDA, to the website. If an application has been loaded on the PDA, he is able to also enter destination and travel dates, offline. They are then transferred from the PDA to the PC.

As an alternative, the traveller enters all his travel requirements onto his portable device and the portable device automatically seeks out a suitable portal to connect to the travel agent, either by General System for Mobile (GSM) communications-like technology or, where no signal exists, by using redundant capacity on a suitably equipped and network device such as a PC. The portable device may establish a secure wireless connection via the other device.

Confirmation details of the travel arrangements may be sent to the portable device. If the portable device has moved outside the range of the subscription content access system, it may continue to poll the travel agent website via any Wireless Access Point on which it can secure a connection. The business traveller now has all his details, including an effective “eTicket.”

Upon arrival at the departure airport, his arrival is announced to the airline by passing through portals at the entrances. Any flight detail changes are automatically relayed to his portable device to alert the passenger. Also sent to the portable device are gate number information and directions to the gate from his point of entry.

The next stage is to pass through the security check. There is no manual checking of tickets required and the security staff are presented with by an image that has been requested from the security portal to verify the traveller. The boarding of the aircraft may similarly be verified.

On arrival at the destination, directions for transfers and ongoing surface travel are sent to the portable device. If the business traveller has chosen to rent a car, his travel on the courtesy bus to the rental compound is transmitted ahead of him to the rental compound and his car is ready for him, all his driver license details having been transmitted. The portable device then receives an immobilizer code from the rental company that allows the business traveller to drive the car. Any unrecognized code will prevent the unauthorized usage of the car. If there are any restrictions on the driver, such as a new driver restricted to a speed limit, these are transferred to the car management system. His destination is also programmed into the car's navigation system.

On arrival at his hotel, again by walking through a portal at the entrance, he is effectively booked in and can proceed immediately to his bedroom where his portable device acts like a room key. On entering his room, he decides he wants to watch his favorite subscription television channel on the television set in the room. The portable device will already have communicated with the set and established a “channel list” based upon the subscriptions the business traveller has stored in his portable device. The business traveller can use his portable device as a remote control.

While staying in the hotel, the business traveller may earn loyalty points as he consumes food and drink and makes use of fee-paying services. These points are be automatically tallied on his virtual loyalty card. His “bill” may be continually updated at each service point he visits. In the room, if he orders room service, the cost may be added.

At checkout time, the business traveller instigates the checkout procedure from his portable device, again confirming payment by his authorization code, using, if appropriate, any redeemable loyalty points.

### EXAMPLE 2

### Bank Card with Cirrus® Features

A person needs to travel abroad urgently and needs access to funds when abroad. With the present technology, the traveller applies for a bank card and the issuing authority sends out a card after one or two days.

With receiver 110 and its inherent security features, the traveller is able to apply for a card at a suitable terminal, the traveller's identity and validation checks are performed electronically and if all is successful, receiver 110 has the issuer's smartcard downloaded and activated without delay.

Basically, system 100 can perform multiple functions, depending on their deployed situation. Receiver 110 integrates all the functions described and dispenses with the complexity of multiple smartcards, governing and sharing cards. Receiver 110 is similar to a mobile phone with PDA, smart card and security functions added that automate many of the tasks facing the consumer, retailer end provider of service through a standard methodology of integrating all the services.

For example, in open country, receiver 110 acts simply like a mobile phone. Within the confines of a hotel it adopts, among other functions, the additional functions of a security key and a billing system. As a bearer approaches a suitably equipped establishment, he enters coverage and a handshake with the establishment takes place, effectively announcing the arrival of the bearer to all the facilities of the establishment. If it is a hotel, the hotel system sends details of his check-in to the device, inform him of his room number and any messages or special facilities and the like. The bearer proceeds to his room, guided by prompts on his device as he passes from coverage area to coverage area, similar in concept to a cell phone passing from one cell to another. On arrival at his room the door is unlocked, automatically, as a security key has been programmed by the hotel system into the portable device. Such key replaces the need for the electronic or punch card systems currently used for hotel security.

On entering the room the entertainment center has already been programmed to receive all the subscription channels and other favorites that the bearer has paid to receive. No longer will his subscription to his Sports Channel, for example, be left unused at home while he travels on business—it will travel with him and his portable device is the key to unlocking the content he subscribes to or already has paid for. Some of the obvious benefits of system 100, seen in the above example, are to remove the need for a manual check-in. On leaving the same process may operate in reverse where the bearer agrees to the invoice presented to him on his portable device, he “approves” it and on departure the checkout is conducted without the usual early morning need to join the checkout queue.

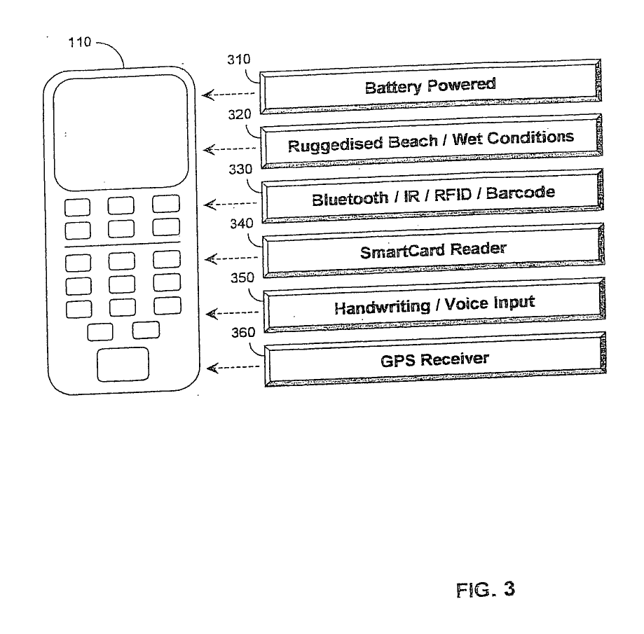

Receiver 110 may incorporates many features and functions, as shown in FIGS. 3-6. In FIG. 3, receiver 110 is battery-powered 310, ruggedised for beach or wet conditions 320, has Bluetooth, infra-red (IR) or radio frequency identification (RFID) interfaces 330, has a smartcard reader 340, can accept handwriting or voice input 350 and incorporates a Global Positioning System (GPS) receiver 360. Receiver 110 may also contain a solar powered backup system for the battery.

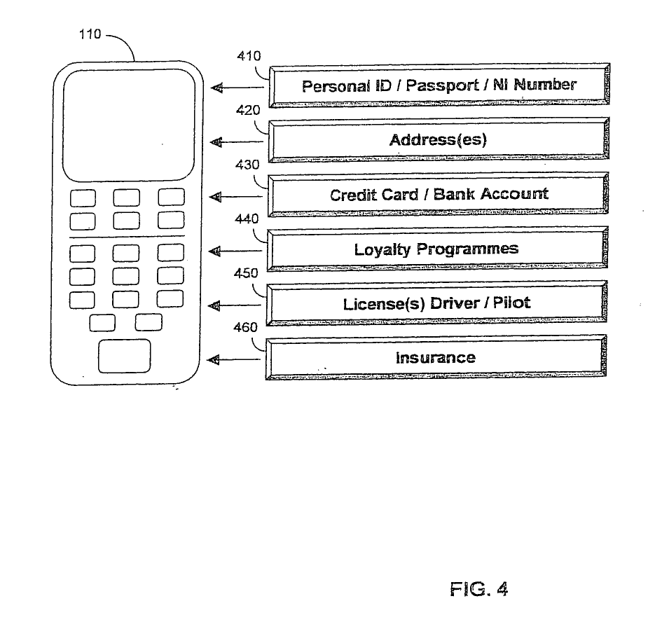

In FIG. 4, receiver 110 allows a variety of functions such as Personal, Passport, National Insurance (NI) or Social Security number use, a picture of the bearer and details such as the NI or Social Security Number are held in a read-only memory (ROM), as shown in 410.

When approaching a passport control (or a similar) station where personal identification has to be verified, the bearer walks through a portal where the information held in ROM may be transmitted to a suitably equipped receiver. Biometrics (such as face recognition or finger prints) may be verified from a central repository based upon connectivity details transmitted. This allows for denial of entry to be automated.

System 100 may also form the basis for photo ID for cash or credit transactions where the point of sale terminal may have a suitable receiver or PIN number or biometrics authorization.

As shown at 420, address details may be automatically transmitted from the portable device for form filling for such applications as large value purchases, hotel reservations or car hires and the like. The address fields may be transmitted in conjunction with other appropriate fields, for example, as described above, a hotel reservation may include information from the Personal ID fields and perhaps car registration information. Preferred payment method, room type and the like may all be included in addition to loyalty scheme information. Moving around the hotel may all be automated using the device. A system to access bedrooms may be used in which the hotel sends an unlock code to the device and then the device in close proximity to the room unlocks the door when in the corridor but locks the door when in the room. Transactions in bars and restaurants may be recorded and a running bill held locally on the device for the user to view during prolonged stays. This only requires provision of wireless access points for the device. With the ability to verify the user, the chance of fraudulent charging to room accounts is removed.

As shown at 430, payments from credit or debit cards may be carried out electronically with the bearer's picture being visible to the retailer or supplier of service. Account transfers between devices may also be permitted. “Lend me some money, please” may result in an electronic handshake between devices. A scheme to prevent “snooping” of details may be used such as setting up a secure link between the devices using encryption prior to authorizing the cash or credit transaction. For multiple card holders on single accounts, the prime account holder may establish the credit limit for the secondary card holders, something that is currently not possible. Running totals of credit may be made available on the device with links available at point of sales (POS) terminals to permit consolidation of all card transactions to happen without user intervention, for example, a husband and wife have two cards on one account; they are near their credit limit but are not together; the person wishing to purchase an expensive item may perform an account enquiry using the device to check their credit limit by entering a command in the proximity of a suitably equipped POS terminal that interrogates the credit card company's mainframe. The portable device may also be used to automatically ticket people as they board passenger craft.

As shown at 440, credits and redemptions from loyalty programs and access to facilities may be held with the device. Airport lounge access, for example, may be automated. Attendants know who is in which lounge and based upon flight details held in the itinerary section of the PDA may page passengers as required. The system may record entry and exit from the lounge. Loyalty points may be awarded automatically rather than having to pass over two cards as typically is presently the case. Association may be made prior to purchases, for example, “I will take air miles rather than vouchers where alternatives are on offer.” In hotels, latest statements may constantly be available for the bearer to redeem points against services. Special offers may be transmitted and received by the device.

As shown at 450, receiver 110 may be used to control access to a road or air vehicle by a driver or pilot, for example, permission to operate or drive heavy goods vehicle (HGV), private car, passenger service vehicle (PSV), and the like. Tachograph records may be linked to onboard computer restrictions on speed or power that can be effected based upon the level of driver license. Roadside checks of drivers for law enforcement may be facilitated. Road tolls may be automatically transferred from a receiver in-car to a personal account. Such a concept is extendable to fares on ferries and the like. Insurance companies may tailor their charges based upon driving style, location (derived from GPS), mileage, day and/or time. To save on local storage, the system may upload at intervals to a centralized database for use at renewal time, or whenever appropriate. This use may also be linked to penalty points and the system may act as a speed limiter on a car. The system may also be used to setup driver preferences for seats and the like.

As shown at 460, an electronic certificate of insurance stored in the portable device can prevent the unauthorized driving of a road vehicle or other machinery that requires insurance to be legally driven (or if a vehicle is being driven without insurance a “Tracker” like signal may be transmitted from the vehicle to alert authorities). In the event of a road traffic accident insurance details can be shared accurately and easily between the parties.

Thus, the portable device may be not just a user's insurance certificate but also the user's driving license so as to prevent unlawful or restricted use of a vehicle and to provide automated insurance cover information. A receiver in a vehicle may be programmed to allow certain people to only be able to access (but not drive) the vehicle. For example, a family member who may not have a license may still open a vehicle to gain access to the passenger facilities. Likewise, friends and families may be programmed into a house security system.

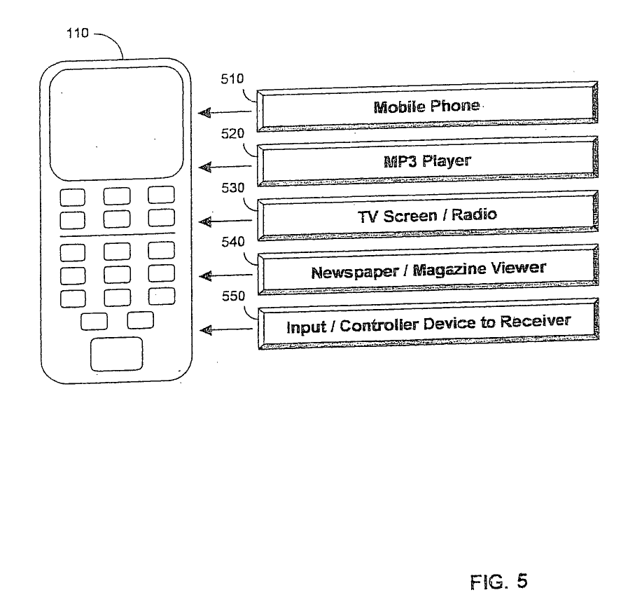

Entertainment functions on receiver 110 are illustrated in FIG. 5. As shown at 510, receiver 110 may be used with standard mobile phone technology capable of taking advantage of new generation facilities using “always on” functionality, permitting the reception and transmission of data when outside the coverage of base stations that are part of system 100.

As shown at 520, receiver 110 may be used as described above to allow the bearer to download music (e.g., MP3 files) from a subscribed to service provider or to upload music he owns.

As shown at 530, receiver 110 may include a handheld portable TV receiver and an FM/AM/Digital radio enabled as necessary through subscription information stored in receiver 110.

As shown at 540, exploiting asymmetry between broad band download speed and narrow band upload speed, the bearer of receiver 110 can receive an electronic copy of his periodicals, for example, newspapers and magazines), enabled as necessary through subscription information stored in the device. This is ideally suited for the travelling user to read the latest edition of his magazine without having to wait until he gets home to read the hardcopy version. It may also permit access to back-issues or allow searches and the like.

As shown at 550, receiver 110 may act as a remote control device for the TV or whatever receiver is currently being used to receive content. However, receiver 110 does not have to “learn” the appropriate codes as a manual exercise, they are instead downloaded automatically to the portable device upon entering into range. A benefit of such feature is that the controls on the portable device retain a constant interface “look and feel” for the user. He does not have to learn the controls of the TV, manufacturer by manufacturer.

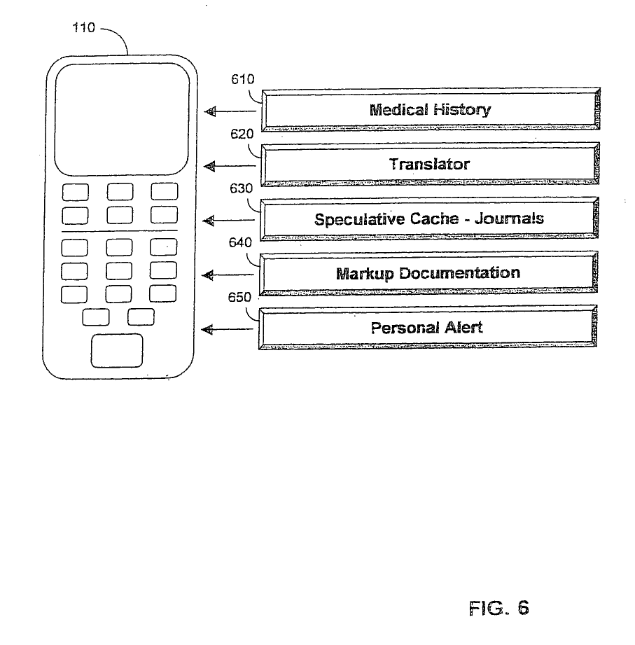

Emergency functions on receiver 110 are illustrated in FIG. 6. As shown, receiver 110 allows a variety of further functions. As shown at 610, receiver 110 may act as a repository for the bearer's medical history. In the event of an accident, any approaching medical staff equipped with a receiver may be alerted to conditions where the bearer may be allergic to or pre-existing conditions that may influence their treatment of the casualty.

As shown at 620, receiver 110 may act as an electronic translator. By declaring the language the user is familiar with, any instructions or forms may be delivered to the portable device for the bearer to read in his native language. Likewise, the bearer may speak a phrase into the portable device in his native language and the translated phrase may be displayed on the screen or output audibly from the device. A certain amount of translation may be stored locally, for example, when in Spain, the Spanish dictionary may be downloaded at a point of entry, or in the presence of a base station a centralized translation engine may be accessed via the base station, using the portable device as the terminal.

As shown at 630, receiver 110 may prefetch information as journals and the like are being accessed. This improves the perceived response of the device as pages are held locally and accessed as such. This allows for the continued use of the portable device in blackout areas.

As shown at 640, receiver 110 may be used to markup or highlight documents as they are being accessed and the markups may be stored centrally for retrieval. This means that any edits are stored and are not lost. The central storage of the document remains untouched, with local storing of highlights or markups of frequently accessed information and merging of the markup information with a freshly received base document from central storage.

As shown at 650, since the portable device is personalized to an individual, incorporating a “Tracker” like capability permits the creation of a personal alert or alarm system. In the event of the bearer feeling threatened they may activate the alarm on the device that transmits the alert to the tracking authorities for them to react. If the device detects that it is no longer attached to the bearer, for example, by a skin contact missing from a probe attached to the device, an alert may be broadcast using a Bluetooth or similar connection. The portable device itself, through its ruggedised construction, may sustain a certain amount of abuse prior to ceasing to function. In that time receiver 110 is capable of transmitting an alert, which if it is not cancelled by the bearer is reacted upon by the correct authorities in the same manner as an Emergency Position Indicating Radio Beacon (EPIRB). Each portable device may be capable of relaying an alert. Utilizing Mayday type procedures, the devices work like VHF radios in the hands of operators. A general broadcast may be issued when the alert has been received, greatly increasing the effective range of the device. In areas where direct transmission is not possible the alert may be carried until a suitable transmitter or receiver is located such as an underground station platform which may be equipped with a receiver. The method of transmission, above ground, for this type of activity may be similar to an EPIRB where satellites receive the emergency signals and relay them to appropriate authorities. “Stand-downs” may be broadcast via a GPS type of satellite network.

System 100 for mobile subscription content access described above provides the following advantages:
1. A single device as opposed to multiple smartcards expanding the capability of mobile phone or PDAs with Bluetooth and/or IrdDa capability to incorporate the additional functions;
2. Immediate availability—smartcards take time to be issued. By using this system the “smartcard” may be loaded onto the portable device using the system infrastructure;
3. Security—the portable device may be associated with the user through biometrics or photo or fingerprints and the like, for example, instead of unlocking the phone with a password, an integrated camera may be used to verify the user's facial features or iris or such like;
4. Automated announcement of arrival and/or presence; and

5. Automatic speculative download and/or caching of subscribed content based on locally stored subscription data;

As has been described, the present invention provides an improved method and system for providing a content subscriber to access content anywhere there is a coverage.

While the invention has been particularly shown and described with reference to a preferred embodiment, it will be understood by those skilled in the art that various changes in form and detail may be made therein without departing from the spirit and scope of the invention.

What is claimed is:

1. A method for providing mobile subscription content access to a subscriber, said method comprising:
storing subscription contents in a server, wherein said subscription content can be accessed via a plurality of terminals coupled to said server by a communication link;
in response to an access to any of said subscription contents on an encrypted subscription channel via one of said plurality of terminals, determining whether or not a valid receiver is found in the proximity of said one terminal;
in a determination that a valid receiver is found in the proximity of said one terminal, transferring an encryption/decryption key to said valid receiver; and
accessing said subscription contents on an encrypted subscription channel via said one terminal and said valid receiver.

2. The method of claim 1, wherein said accessing further includes transferring said subscription contents to said valid receiver.

3. The method of claim 2, wherein said accessing occurs wirelessly between said terminal and said valid receiver.

4. The method of claim 3, wherein said accessing occurs wirelessly between said terminal and said valid receiver via Bluetooth or infra-red.

5. The method of claim 1, wherein said communication link is the Internet.

6. The method of claim 1, wherein said determining further includes checking biometrics of a holder of said valid receiver to verify the identity of said holder.

7. A system for providing mobile subscription content access to a subscriber, said system comprising:
a server for storing subscription contents, wherein said subscription content can be accessed via a plurality of terminals coupled to said server by a communication link;
means for determining, in response to an access to any of said subscription contents on an encrypted subscription channel via one of said plurality of terminals, whether or not a valid receiver is found in the proximity of said one terminal;
means for transferring, in a determination that a valid receiver is found in the proximity of said one terminal, an encryption/decryption key to said valid receiver; and
means for accessing said subscription contents on an encrypted subscription channel via said one terminal and said valid receiver.

8. The system of claim 7, wherein said means for accessing further includes means for transferring said subscription contents to said valid receiver.

9. The system of claim 8, wherein said means for accessing provides wireless access between said terminal and said valid receiver.

10. The system of claim 9, wherein said means for accessing provides wireless access between said terminal and said valid receiver via Bluetooth or infra-red.

11. The system of claim 7, wherein said communication link is the Internet.

12. The system of claim 7, wherein said means for determining further includes means for checking biometrics of a holder of said valid receiver to verify the identity of said holder.

13. A mobile receiver capable of receiving subscription contents from a mobile subscription content access system, wherein said mobile subscription content access system includes a server and a plurality of terminals coupled to said server via a communication link, wherein said subscription contents are stored in said server, said mobile receiver comprising:
continuously detecting a suitably equipped terminal within said mobile subscription content access system;
in response to a detection of a suitably equipped terminal, transferring an encryption/decryption key to said terminal; and
accessing said subscription contents on an encrypted subscription channel via said one terminal and said valid receiver.

14. The mobile receiver of claim 13, wherein said mobile receiver is a mobile phone.

15. The mobile receiver of claim 13, wherein said mobile receiver is a personal digital assistant.
